(19) United States
(12) Patent Application Publication
(10) Pub. No.: US 2011/0079058 A1
(43) Pub. Date: Apr. 7, 2011

(54) Locking Top for Container

(76) Inventors: Simon S. Nielsen, El Segundo, CA (US); Manuel A. Montano, El Segundo, CA (US); Henry K. Yu, El Segundo, CA (US)

(21) Appl. No.: 12/892,909

(22) Filed: Sep. 28, 2010

Related U.S. Application Data
(60) Provisional application No. 61/277,714, filed on Sep. 28, 2009.
(60) Provisional application No. 61/359,348, filed on Jun. 28, 2010.

(51) Int. Cl. E05B 65/52

(52) U.S. Cl. 70/158

(57) ABSTRACT

A locking apparatus for containers, vials and bottles comprises a combination lock to be applied to a generic bottle or vial or for a custom bottle. The locking apparatus comprises a locking subassembly: a housing, a collapsible portion on the housing or on a separate washer piece, at least one indicia ring, at least one tumbler key ring, and a setting plug; the locking subassembly will engage a first bracket, which can be mounted on a generic bottle or vial or to a custom bottle with a top end, which has a integrated bracket end.

This application claims the benefit of U.S. Provisional Patent Appl. No. 61/277,714, filed on Sep. 28, 2009 and U.S. Provisional Patent Appl. No. 61/359,348, filed on Jun. 28, 2010; these applications are incorporated by reference in entirety.

### BACKGROUND OF THE INVENTION

1. Field of the Invention

The field of the invention relates to locking caps or closures for containers and bottles.

2. Description of Related Art

Prior to the present invention, most locking caps for medicine or pill vials or containers were intended to prevent children from accessing the interior contents. These child-proof types of medicine bottle caps could effectively keep out children but not adults. With the advent of increasingly expensive medications and prescription drugs, there is a need for a locking cap or top, which can fit a standard sized medicine container or vial. From the preceding descriptions, it is apparent that the devices currently being used have significant disadvantages. Thus, important aspects of the technology used in the field of invention remain amenable to useful refinement.

### SUMMARY OF THE INVENTION

This invention relates to a locking top for vials, containers and bottles, and in particular, for vials for medicines and prescription drugs. This locking top or cap comprises a locking cover and a closure assembly; the closure assembly has a first or bottom portion and a second or top portion. The bottom portion of the closure assembly mates with any vial or container; the top portion of the closure assembly, which has a locking cover, engages the bottom portion of the closure assembly such that the top and bottom portions are permanently connected to the opening of the vial or container, once the flanges are engaged.

An apparatus for locking a container comprising: a locking assembly comprises: a housing, a collapsing portion in the housing, at least one indicia ring, at least one tumbler key, a setting plug and a first bracket; the locking assembly engages a second bracket, which sandwiches an opening on the container; whereby after the at least one indicia ring engages the at least one tumbler key at a specific locking combination; the locking assembly is snapped together to break or bend the collapsing portion in the housing to allow the permanent engagement of the specific locking combination of the at least one indicia ring and the at least one tumbler ring to the first bracket; the setting plug is removed; and the locking assembly is permanently engaged to the second bracket so that the container can only be opened with the specific locking combination of the locking assembly. The housing can also have a channeled relief surface, at least one display window for viewing the at least one indicia ring, at least one retaining clip on a lower portion of the housing; said at least one retaining clip applies an upward force to help align the at least one indicia ring and at least one tumbler key; at least one detent structure on an inner surface of the housing. The apparatus for locking a container, wherein the collapsing portion is on a separate washer, which lies within the housing; the at least one indicia ring has a first side and a second side; the first side has at least one detent receiver space and at least one indicia marking; the second side of the indicia ring has at least one inner engagement boss; and the at least one tumbler key has at least one outer engagement portion and at least one vertical channel and at least one horizontal channel; the at least one tumbler key has at least one inner engagement boss on an inner surface of the at least one tumbler key.

An apparatus for locking a container comprising: a locking assembly comprises: a housing, a collapsing portion in the housing, at least one indicia ring, at least one tumbler key, a setting plug and a first bracket, the first bracket is part of the container, whereby after the at least one indicia ring engages the at least one tumbler key at a specific locking combination; the locking assembly is snapped together to break or bend the collapsing portion in the housing to allow the permanent engagement of the specific locking combination of the at least one indicia ring and the at least one tumbler ring to the first bracket; the setting plug is removed; and the locking assembly is permanently engaged to the first bracket so that the container can only be opened with the specific locking combination of the locking assembly.

The present invention introduces such refinement. In its preferred embodiments, the present invention has several aspects or facets that can be used independently, although they are preferably employed together to optimize their benefits. All of the foregoing operational principles and advantages of the present invention will be more fully appreciated upon consideration of the following detailed description, with reference to the appended drawings.

### BRIEF DESCRIPTION OF THE DRAWINGS

FIG. 1 is an exploded view of one preferred version of the invention, with the locking subassembly, the first bracket, the bottle and the second bracket; the locking subassembly is in the first or pre-set position.

FIG. 2 is a cross-sectional view of the embodiment shown in FIG. 1

FIG. 3 is view of the embodiment shown in FIG. 1, wherein the first and the second brackets sandwich the upper end of the bottle; the locking subassembly is in the second or post-set position.

FIG. 4 is a cross-sectional view of the embodiment shown in FIG. 3.

FIG. 5 is a plan elevation view of the assembled embodiment of the invention.

FIG. 6 is a cross-sectional view of the embodiment shown in FIG. 5.

FIG. 7 is another exploded view of embodiment shown in FIG. 1.

FIG. 8 is a cross-sectional view of the embodiment shown in FIG. 7.

FIG. 9 is an exploded view of another embodiment of the invention with the locking subassembly and a bottle with a custom upper end of the bottle; the locking subassembly is in the first or pre-set position.

FIG. 10 is a cross-sectional view of the embodiment shown in FIG. 9.

FIG. 11 is an exploded view of the embodiment with the locking subassembly in the second or post-set position.

FIG. 12 is a cross-sectional view of the embodiment shown in FIG. 11.

FIG. 13 is a plan view of the fully assembled embodiment.

FIG. 14 is a cross-sectional view of the embodiment shown in FIG. 13.

FIG. 15 is an exploded view of another embodiment;

FIG. 16 is a cross-sectional view.

FIG. 17 is a bottom view of the housing;

FIG. 18 is a perspective view of the housing;

FIG. 19 is a first plan view of the housing;

FIG. 20 is a second plan view of the housing;

FIG. 21 is a third plan view of the housing (fourth plan view is a mirror image of the third plan view).

FIG. 22 is a top plan view of the housing.

FIG. 23 is top plan view of the collapsible washer.

FIG. 24 is a perspective view of the collapsible washer.

FIG. 25 is a side plan view of the collapsible washer.

FIG. 26 is a top plan view of the indicia ring; note the inner engagement structures on the inner surface of the ring and the detent receiver spaces on the outer surface of the indicia ring.

FIG. 27 is a perspective view of the indicia ring.

FIG. 28 is a side plan view of the indicia ring.

FIG. 29 is a bottom plan view of the tumbler key ring; note that the inner surface of the ring has inner engagement structures, which are to engage the vertical slots or channel on the setting plug, or the first bracket, or the custom upper end of the bottle.

FIG. 30 is side plan view of the tumbler key ring structure.

FIG. 31 is a perspective view of the tumbler key ring structure.

FIG. 32 is a top plan view of the tumbler key ring; note that the inner surface of the ring has inner engagement structures, which are to engage the vertical slots or channel on the setting plug, or the first bracket, or the custom upper end of the bottle.

FIG. 33 is a bottom plan view of the setting plug structure.

FIG. 34 is a perspective view of the setting plug structure.

FIGS. 35, 36 and 37 are a first, second and third side plan view of the setting plug structure.

FIG. 38 is a top plan view of the setting plug structure.

FIG. 39 is a bottom plan view of the vial or bottle as shown in FIG. 9-16.

FIGS. 40, 41 and 42 are a first, second and third side plan view of the vial or bottle as shown in FIG. 39.

FIG. 43 is a perspective view of the vial or bottle as shown in FIG. 9-16.

FIG. 44 is a top plan view of another embodiment of the invention (as shown in FIG. 9-16), namely the vial or bottle that has an integrated first and second bracket, which comprises the top end of the vial or bottle. The top or first end of the bottle has structures that mimic or copy the first bracket as show in FIG. 45-49.

FIG. 45 is a bottom plan view of the first bracket structure.

FIG. 46 is a perspective view of the first bracket structure.

FIGS. 47 and 48 are first and second side plan views of the first bracket structure.

FIG. 49 is a top plan view of the first bracket structure.

FIG. 50 is a bottom plan view of the second bracket structure.

FIG. 51 is a perspective view of the second bracket structure.

FIGS. 52 and 53 are first and second side plan views of the second bracket structure.

FIG. 54 is a top plan view of the second bracket structure.

FIG. 55 is an exploded view of another embodiment that has collapsing part or boss integrated into the inner surface of the housing 10;

FIG. 56 is a cross-sectional view of FIG. 55. In FIG. 55-56, the settling plug 60 has already been removed.

FIG. 57 is a perspective view of the apparatus prior to removal of the setting plug;

FIG. 58 is a cross-sectional view of FIG. 57.

FIG. 59 is a perspective view of the apparatus after setting of the locking apparatus;

FIG. 60 is a cross-sectional view of FIG. 59.

FIG. 61 is a view of the housing for locking subassembly of FIG. 55;

FIG. 62 is a cross-sectional view of FIG. 61.

FIG. 63 is a view of the housing for the locking subassembly after the collapsing parts 32 have been pressed;

FIG. 64 is a cross-sectional view of FIG. 63.

FIG. 65 is an exploded view of another embodiment of the universal version of the invention;

FIG. 66 is a cross-sectional view of FIG. 65; these versions have the day counter indicia on the collapsible washer.

FIG. 67 is a top view of the housing with a window, which shows the day indicia on the top portion of the collapsible washer.

FIG. 68A shows the fully assembled embodiment shown in FIG. 65-67; FIG. 68B is a cross-sectional view.

FIG. 69-70 are exploded and exploded cross-sectional views of another embodiment with the spacers on a removable tab 122; note that the removable plug has been already removed and is not shown in these views.

FIG. 71-72 are perspective and cross-sectional views of another embodiment with the spacers on a removable tab 122 in pre-assembly.

FIG. 73-74 are perspective and cross-sectional views of another embodiment with the spacers on a removable tab 122 in post-assembly.

### PARTS LISTING

10 housing for locking subassembly
12 channeled relief
14 display window
16 alignment receiver
18 receiving clip
22 interface window
26 tumbler detent
30 collapsing washer
32 collapsible part or portion
40 indicia ring
42 indicia panel
44 detent receiver
46 inner engagements
50 tumbler key
52 outer engagements
54 inner engagements
56 horizontal channel
58 vertical channel
60 setting plug
62 base flange (first flange)
64 inner flange (second flange)
66 vertical channel on setting plug
70 pull
72 1st alignment key on setting plug
80 bottle
82 vertical channel
84 horizontal channel
86 2^{nd} alignment key
100 first bracket
106 3^{rd} alignment key
108 engagement tabs on the periphery of the first bracket (to engage the second bracket)
110 second bracket
114 first flange
116 second flange
118 slot for engagement with first bracket's alignment key 106
120 bottle
122 removable tab
124 detents
126 window on top portion of housing 10
128 indicia on top portion of collapsible washer

### DESCRIPTION OF THE PREFERRED EMBODIMENTS

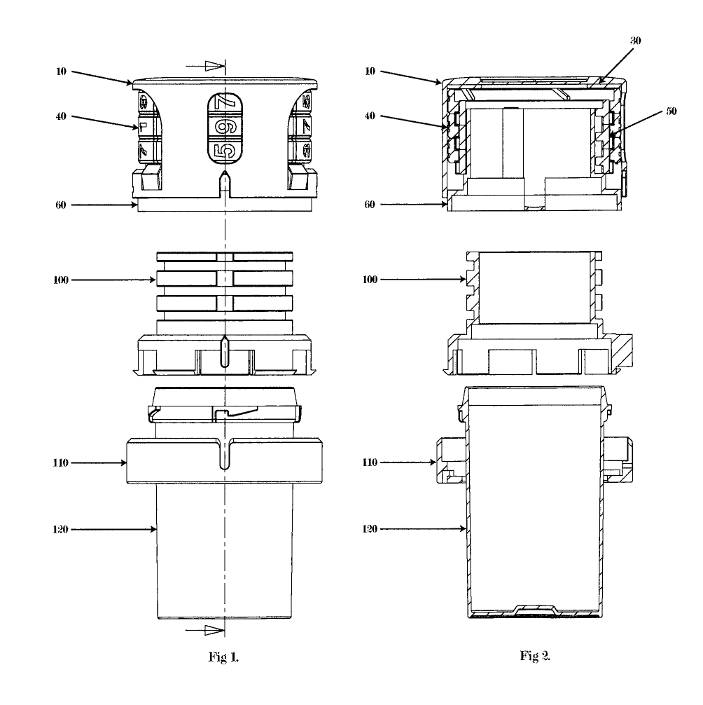

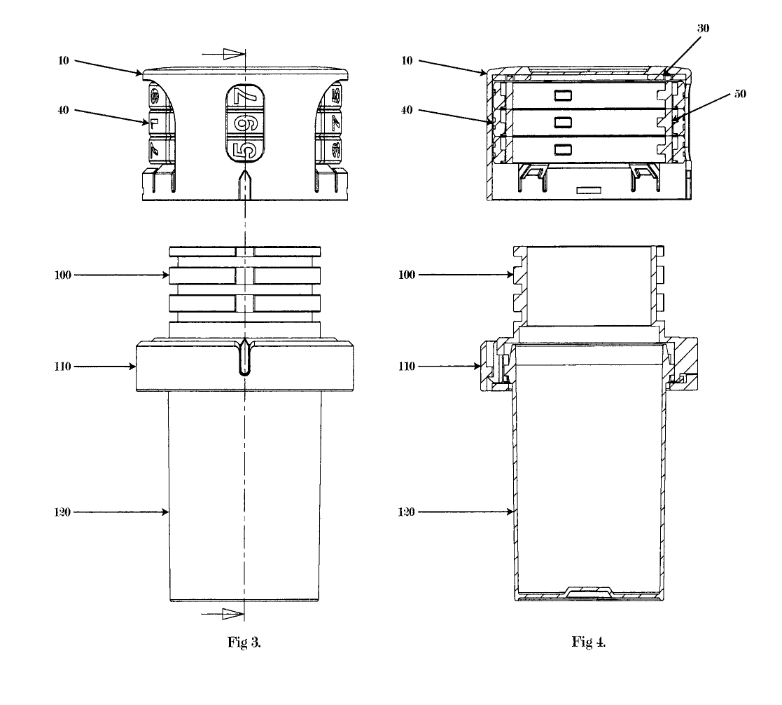

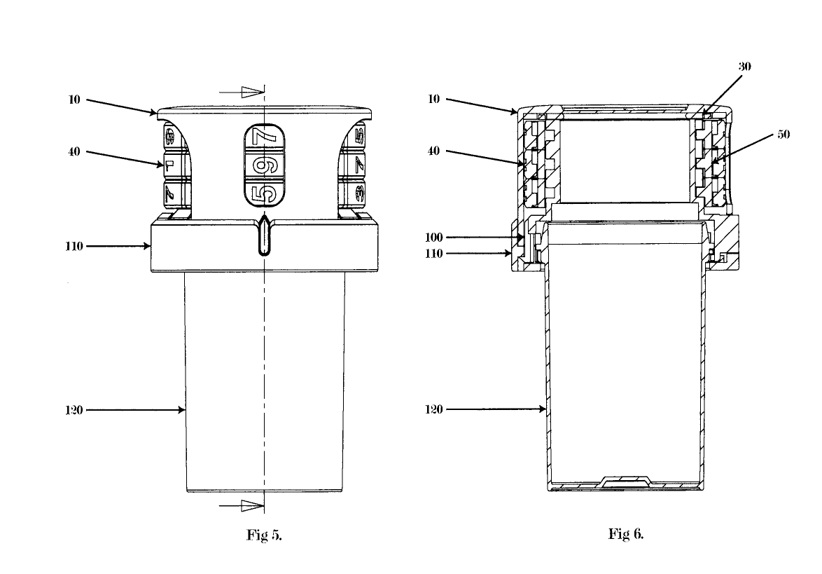

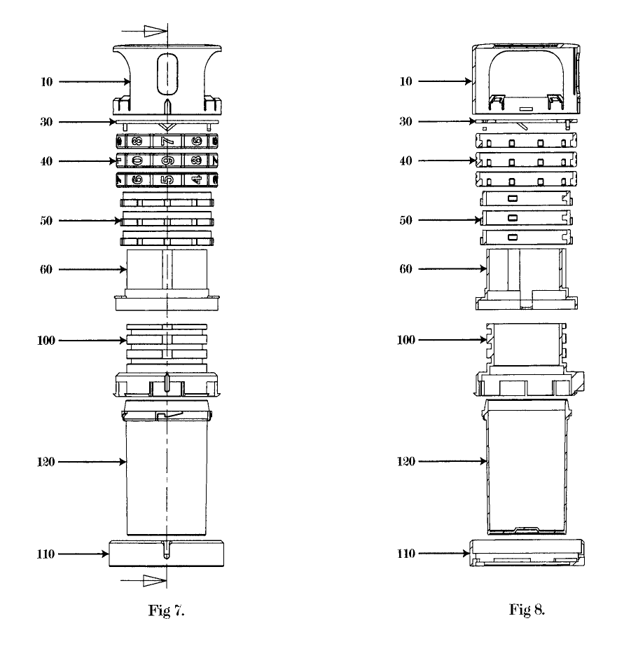

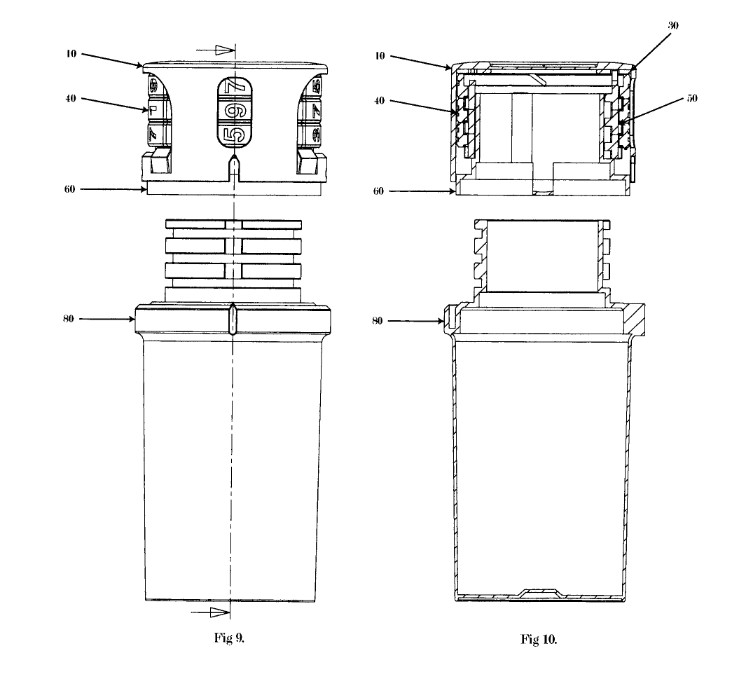

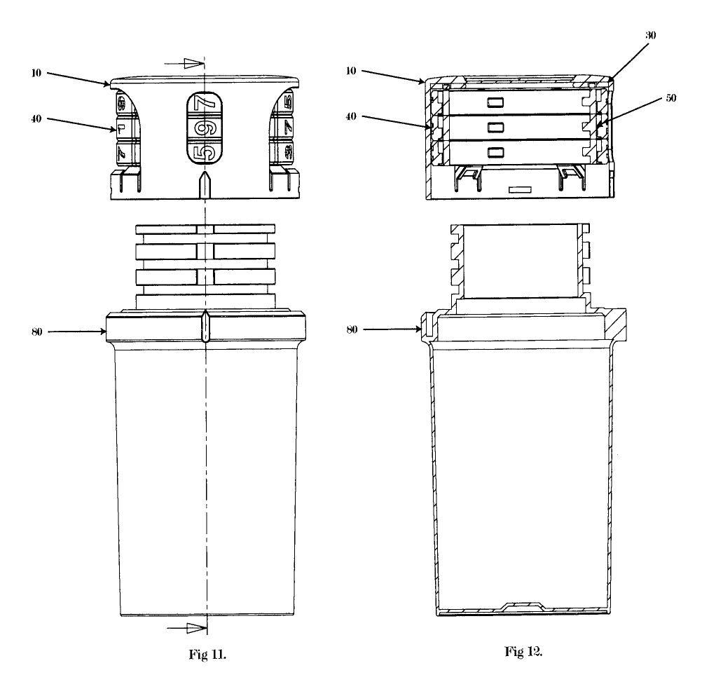

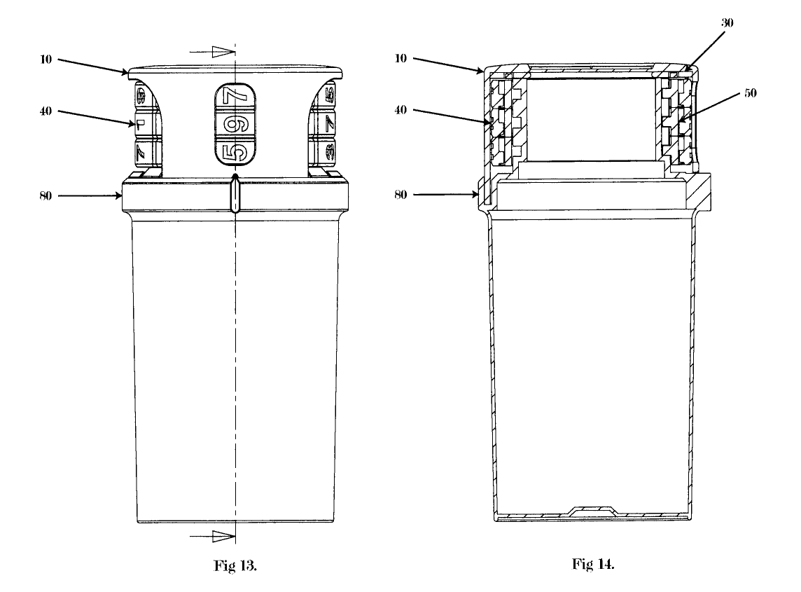

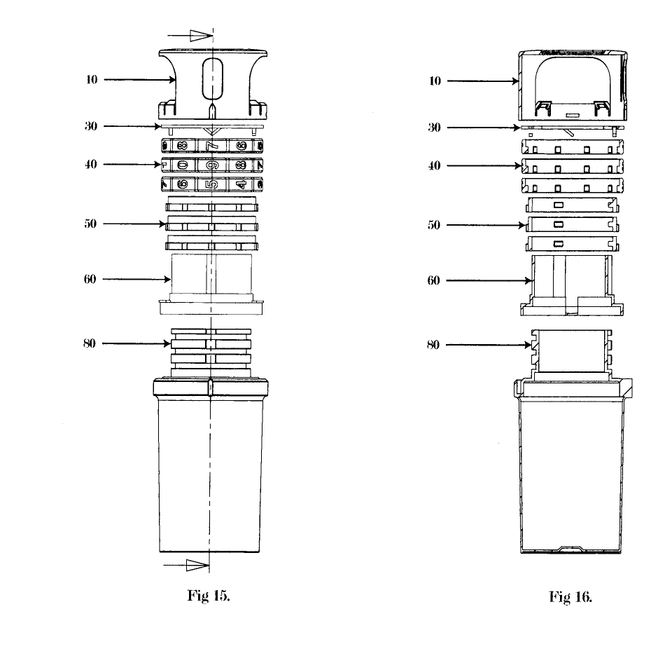

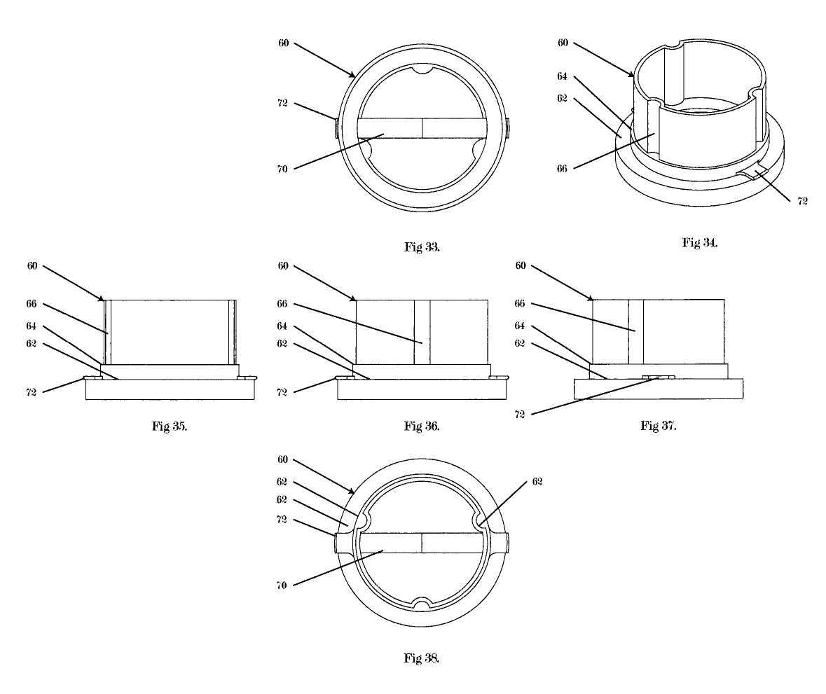

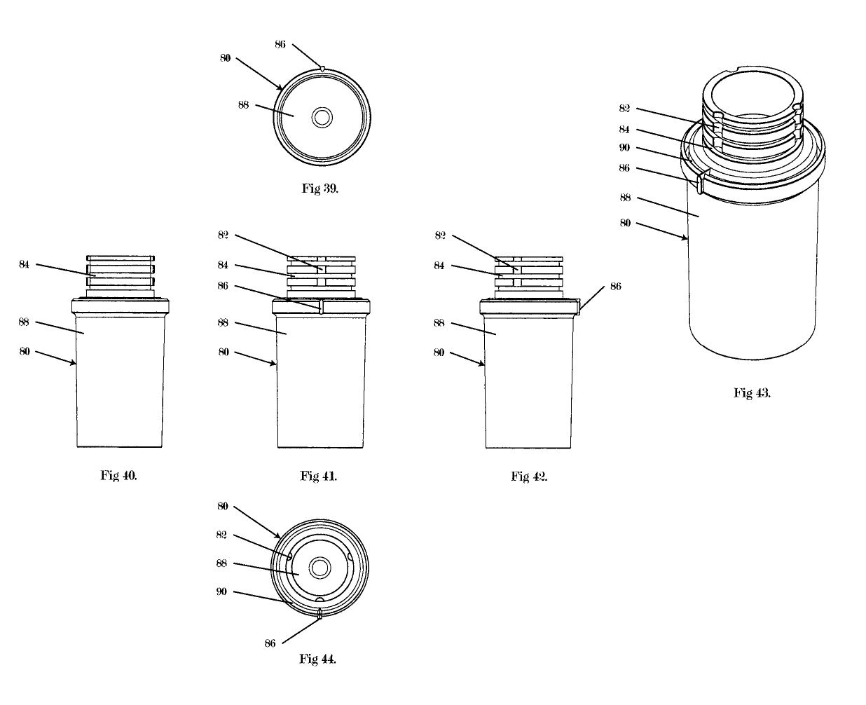

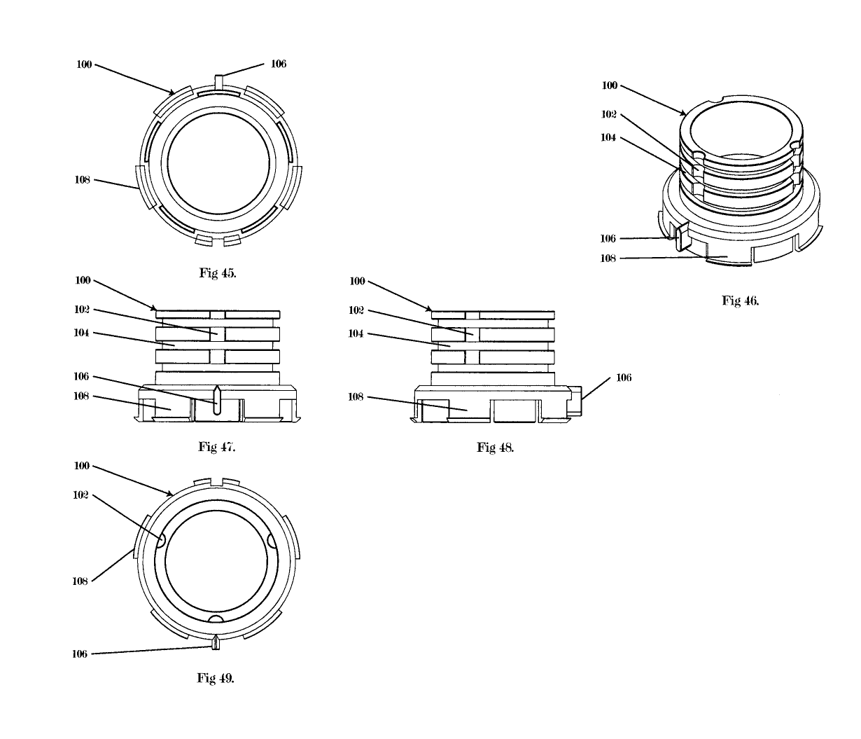

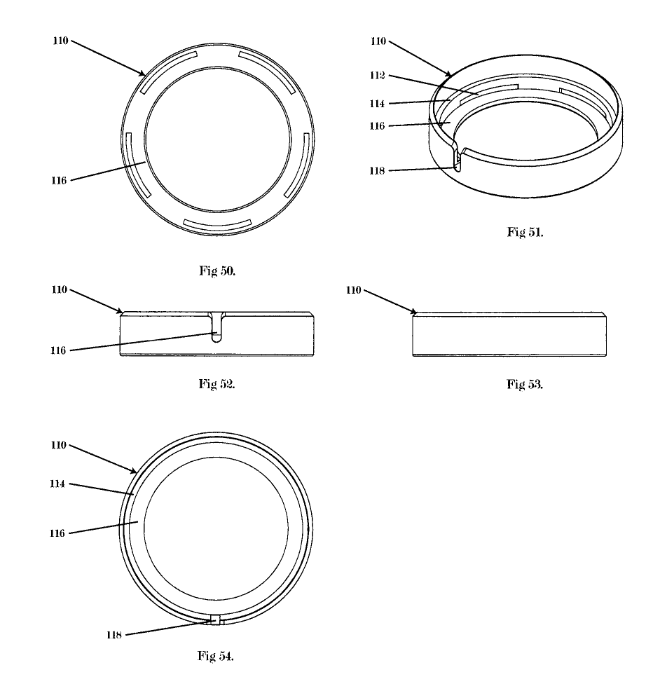

According to certain embodiments as disclosed in this application and in FIGS. 1-54, there is illustrated a locking apparatus for a container, vial or bottle. There are two basic versions:
1. Universal version that can fit on a standard medicine container or bottle (FIG. 1-8; 45-54);
2. Second bracket is integrated into the top portion of the custom medicine container or bottle (FIG. 9-16; 39-44).
   Parts common to both versions are shown in FIG. 17-38.

Universal Locking Top: As shown in FIGS. 1-8; 17-38; and 45-54, this invention presents a locking cap/top or locking apparatus for a standard bottle or medicine container; this embodiment comprises a locking subassembly, a first bracket and a second bracket.

The closing assembly has a first or bottom section and a second or top section. The bottom section acts a male piece, which securely engages the top section as a female piece in a male/female interaction. This first or bottom section can be molded as an integral part of a container or bottle or it can be a universal piece (1st and 2nd bracket) to be engaged on the top end of a standard bottle.

This engagement of the top and bottom portions of the closing assembly creates a foundation for the locking cover to be the only way to access the closed container or vial. In other words, once the top and bottom portions of the closing assembly are mounted on the open end of a container or vial, the closing assembly cannot be removed from the vial without breaking the closing assembly and/or vial, and the user must unlock the locking subassembly to gain access to the inside of the vial or container.

Locking Sub-Assembly comprises a housing, collapsing washer, indicia ring, tumbler key, and setting plug.

Housing: As shown in FIG. 17-22, there is a housing with a first housing end (top) and a second housing end (bottom); the housing body can have at least one window, which allows access to the combination lock (indicia ring and tumbler key ring assembly) within the housing body.

The top of the housing can have a channeled relief surface or divots or scoring marks, which when broken can show if the locking top has been accessed without authorization. This relief surface of the top of this housing provides a valuable feature of tamper indication, while also offering emergency access to the contents. It can show whether someone has accessed or attempted to access the vial bottle. This channeled relief surface preferably is made of the same material as the rest of the top, but this feature is not intended to be limiting, and other materials or plastics of different durometer as compared to the rest of the housing can be used. However, this channeled relief area should be strong and resilient enough to prevent inadvertent opening of the locking top surface.

The bottom of the housing has at least one retaining clip, which touches the lower portion of the lowest indicia ring and tumbler key (at the point of first, pre-set or pre-combination setting). When the locking subassembly has its locking combination set (second, post-set or post-combination setting), the at least one retaining clip on the bottom portion of the housing applies slight upward force to keep the indicia rings and tumbler keys into proper alignment.

The bottom of the housing also has at least one alignment receiver or notch to help the user align the indicia rings/tumbler keys during use of the lock and also the first and second brackets. The at least one window on the housing helps the user see the number/indicia on the indicia rings.

The inside of the housing also has boss structures or tumbler detents, which helps align the indicia rings/tumbler keys within the housing body.

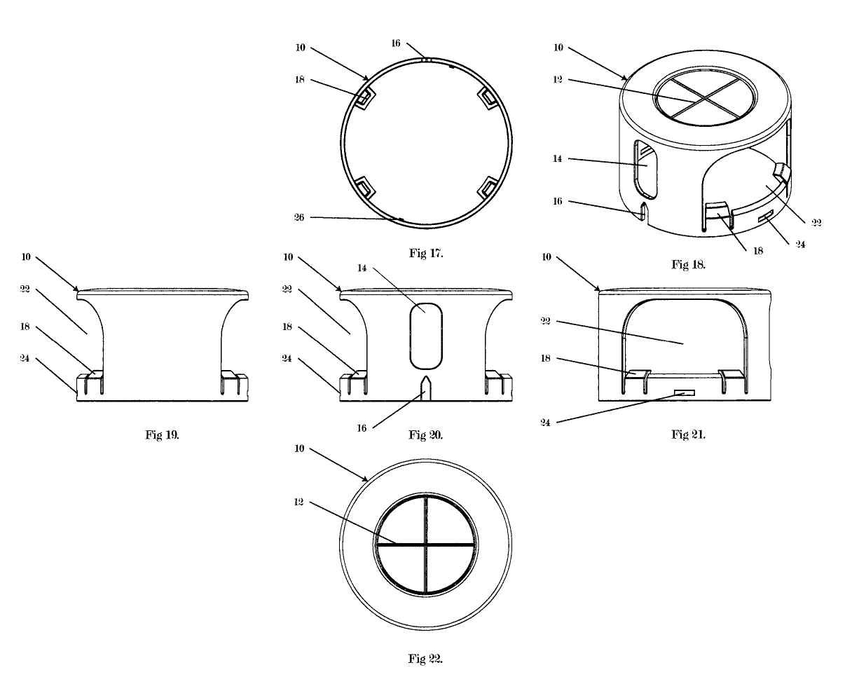

Collapsing washer: As shown in FIG. 23-25, there is a washer with at least one breakaway or collapsing portion that allows the washer to collapse or move from a first or higher elevation to a second or lower elevation within the housing. These breakaway portions are described as an area that breaks away or collapses to allow the washer to move vertically or allows the indicia and tumbler key rings to move to a second or set position (after the user has set the desired combination and snapped the locking subassembly together).

This snapping of the parts together, will stretch, deform, break or collapse the “breakaway” or collapsible portion of the washer so that the indicia rings and the tumbler key rings can align up properly with the outer surface or vertical channels on the setting plug and eventually with the first bracket's outer surface vertical channels and horizontal channels. Further, the indicia ring can move vertically to align with the outer vertical channels on the outer surface of the tumbler key ring. See also the relationship of the horizontal channel (56) and the vertical channels (58) on the outer surface of the tumbler key ring (see FIG. 30-31).

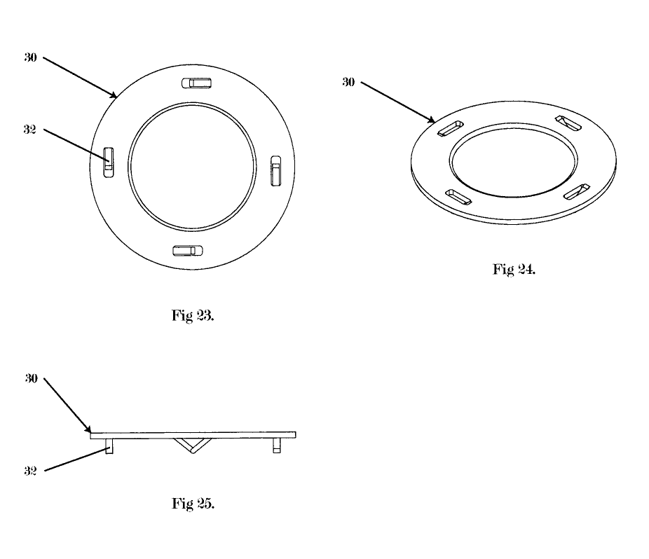

Indicia ring: As shown in FIG. 26-28, there are indicia rings with a first or outer side and a second or inner side. The first or outer side has detent receiver spaces to removably engage the detent boss structures on the inner surface of the housing; the combination of the detent bosses and detent receiver spaces provide the ability for the user to rotate the indicia rings in measured and certain movement when the indicia ring is rotated from a first detent receiver space to a second detent receiver space. These detent bosses and receiver spaces can be omitted, but these items do help make it easier for the user to move the indicia rings and tumbler key assembly. Both the indicia rings and tumbler key rings rotate around a vertical axis of the housing.

Also, the first or outer side of the indicia rings has areas for indicia such as letters, numbers, colors or symbols (Braille). These letters, numbers or symbols can be raised so that the user can feel the indicia with their fingertips.

The inner surface of the indicia ring has inner engagement bosses or protrusions or bumps, which are placed at a lower elevation (see FIG. 27). These inner engagement bosses or structures relate to vertical channels on the outer surface of the tumbler key (see FIG. 31). When the locking subassembly has the desired combination set, the user will press down on the locking subassembly, the breakaway portion of the washer will collapse, and then these inner engagement bosses are able to move vertically within and engage the tumbler key's outer vertical channels.

The indicia rings and the tumbler key rings can have movement both up and down (vertically) and around (horizontally) in relation to the vertical axis of the housing or bottle.

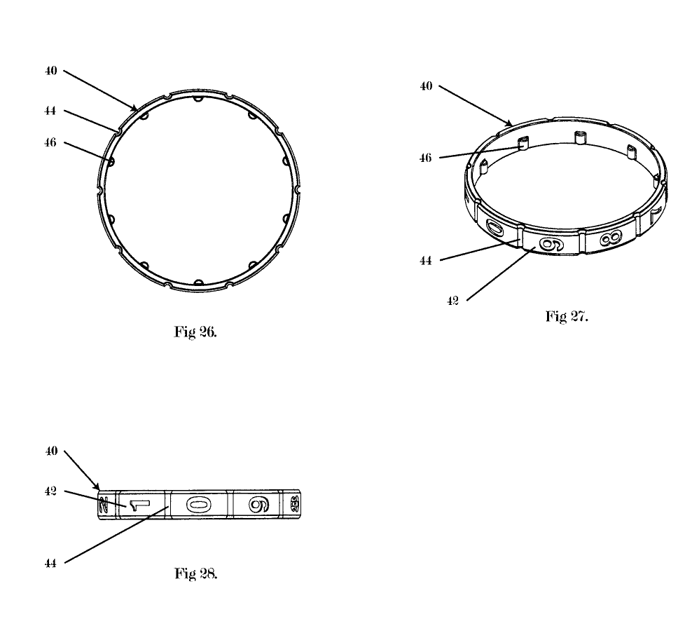

Tumbler key: As shown in FIG. 29-32, there are tumbler key structures, which are ring shaped to mimic the indicia ring; the tumbler key has a first or outer surface and a second or inner surface.

The first or outer surface of the tumbler key ring has an outer engagement portion or ledge and at least one vertical channel (which corresponds to the inner engagement bosses on the inner surface of the indicia ring inner surface) and a horizontal channel. The horizontal channel is formed by the outer engagement portion or ledge, which is located on the lower portion of the tumbler key ring. FIG. 29 shows ten vertical channels to correspond to ten inner engagement structures as shown in FIG. 26.

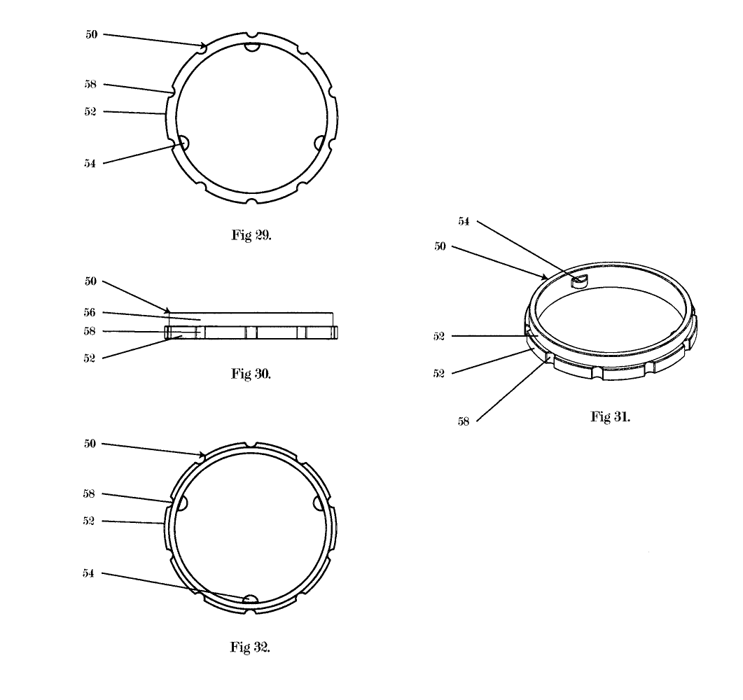

The second or inner surface of the tumbler key has at least one inner engagement boss (see FIG. 31); in FIGS. 29 and 32, there are preferably three inner engagement bosses. These inner engagement bosses will engage the channels on the vertical channel on the setting plug outer surface and then the outer surface of the first bracket.

Setting plug: As shown in FIG. 33-38, there is a setting plug structure, which has a first end and a second end; the first end has a smaller circumference than the second end. There is an outer surface and an inner surface; the outer surface has at least one vertical channel, which are able to engage the inner engagement boss structures on the inside surface of the tumbler keys; in FIG. 33-38, the preferred embodiment shows three vertical channels, which are unequally spaced around the plug structure and would align and engage with the inner engagement structures or bosses on the inner surface of the tumbler key ring structure.

The lower end of the setting plug, there are two flange structures: (1) base flange; and (2) inner flange. The inner flange is at a higher elevation on the setting plug than the base flange; the base flange is preferably greater in width than the inner flange.

At the lower end of the setting plug and arising from the base flange, there is at least one first alignment key, which prevents unwanted movement around and up and down the axis of the apparatus. The preferred embodiments show two alignment keys, which are equal distance from one another. These two alignment keys require vertical channels of the outer surface of setting plug to be unequally spaced; however, other embodiments may allow for different spaced arrangement of the vertical channels and the alignment keys.

Other embodiments may also allow for cut-out portions near the at least one first alignment key, which may help the user release or pull out the setting plug after the locking assembly has set the combination.

The purpose of the setting plug is to help keep the indicia ring and tumbler key rings within the housing (or from falling out) and to help align up the setting (as desired by the user's directed combination or alignment of the specific indicia keys and the tumbler keys).

Other embodiments of the invention may allow for other shapes for the setting plug; the main purpose of the setting plug is to keep the locking subassembly from falling out the housing or to prevent the tumbler keys from spinning until the combination has been set and secured to the first bracket or first bracket end.

First Bracket: As shown in FIG. 45-49, there is a first bracket, which will engage with the locking sub-assembly (after the combination has been set by the user and sub-assembly has been placed in its second or ready for use position); there is a first or upper end and a second or lower end; the first end has both vertical and horizontal channels, which are perpendicularly oriented with respect to one another. The first bracket will mimic the shape of the setting plug; the first bracket has both vertical and horizontal channels on the upper end or the end with the relatively smaller circumference (as compared to the second or bottom end), but the setting plug will have at least one vertical channel. The horizontal channels allow the indicia rings and tumbler key rings to rotate around the vertical axis.

On the lower portion of the first bracket there is a flange and at least one clip. This clip and flange will engage the second bracket around the mouth of the bottle (i.e. engage spaces or slots on the second bracket).

There is also an indicator for allowing proper alignment of the housing of the locking subassembly and also the second (lower bracket).

Second bracket: In FIG. 50-54, there is second bracket component that has a first flange (114) and a second flange (116); the first flange engages the lower portion of the housing; the second flange engages the lip on the bottle. There are also slots to help engage the clips on the lower portion of the first bracket.

This second bracket component is for the universal lock top apparatus, which can be used and made for any generic pharmacy bottle or cup or vial. As shown in FIG. 39-44, the first and second brackets are actually molded into the top of the cup and vial.

### How to Use the Locking Top (Universal Top Version):

1. After assembling the housing with the collapsible washer, indicia rings, tumbler key rings and setting plug, the user will rotate the indicia rings to the desired combination. As noted above, the collapsible washer vertically aligns the locking subassembly so that the indicia rings can rotate freely around the axis of the housing and so that the user can select the proper indicia (numbers, symbols, etc.) to set the desired or particular combination. In the pre-set position, the indicia ring's inner engagement boss parts are able to move within the horizontal channel of the tumbler key ring (outer side).
2. Once the desired combination is selected, the user will press down the housing against the setting plug to “set” the locking subassembly to this desired combination. With this applied pressure, the collapsible portion of the collapsible washer will break or deform to allow a certain amount of vertical movement within the housing (from a first position to a second position). During this movement from a first position to a second position, the inner engagement boss parts on the inner surface of the indicia ring are able to engage the vertical channels of the outer surface of the tumbler key ring. The vertical channels of the outer surface of the tumbler key ring are at a lower elevation than the tumbler key ring's horizontal channel. In addition, the tumbler key's inner engagement boss parts are able to engage the vertical channels on the setting plug.
3. The user will place the bottle in the second bracket's central opening and then place the first bracket over the bottle or vial opening so that the first and the second brackets will sandwich the top end of the vial or bottle. This sandwich engagement of the first and second brackets around the top end of the bottle or vial is permanent and non-removable without breaking or cutting the bottle or vial.
4. Once the locking subassembly has been set, the user can remove the setting plug (a pull tab can be used) and engage the locking top to the first bracket, which has already been connected to the second bracket. The first bracket's first or upper end will mimic the shape of the first or upper end of the setting plug, but the first bracket has at least one horizontal channel to allow movement of the indicia rings and tumbler keys.
5. Since the first and second brackets will sandwich the vial or bottle, once the housing with the locking subassembly has been engaged to the first bracket, the only way to open the bottle is to enter the proper combination to release the locked top.
For Use of the Invention with a Customized Bottle or Vial with an Integral First Bracket:

For versions of the invention to be used on a customized bottle or vial with an integral first bracket, after the user sets the desired combination on the locking subassembly, applies pressure to the locking subassembly to break the collapsible portion on the washer and set the lock combination, removes the setting plug, the user will simply engage the custom bottle top with the housing and set locking subassembly.

Regarding materials, plastics are the preferred materials, but without being limiting different plastics and possibly some alloys or metals or composite and natural composites could also be used.

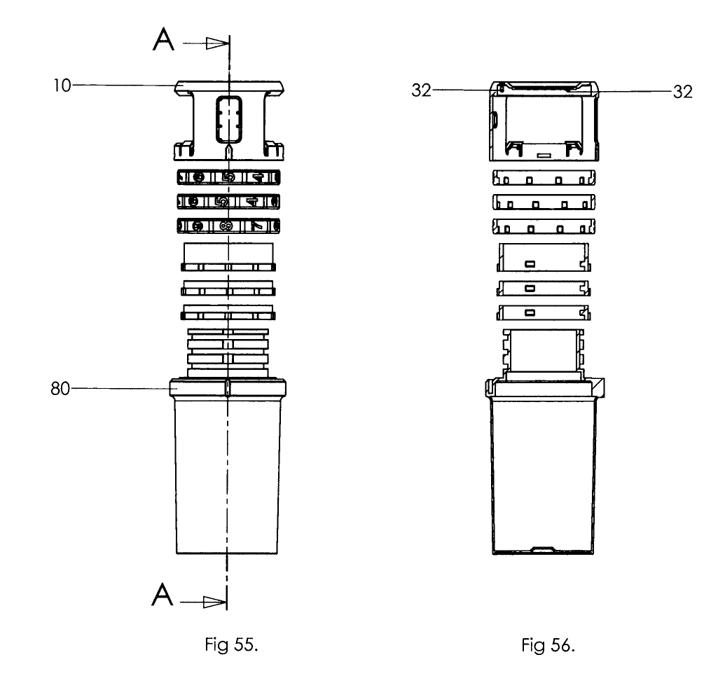

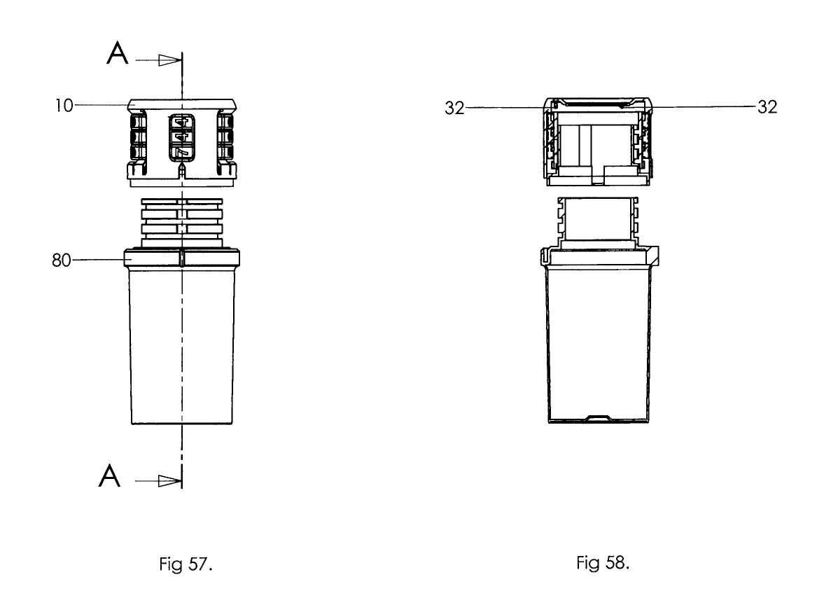

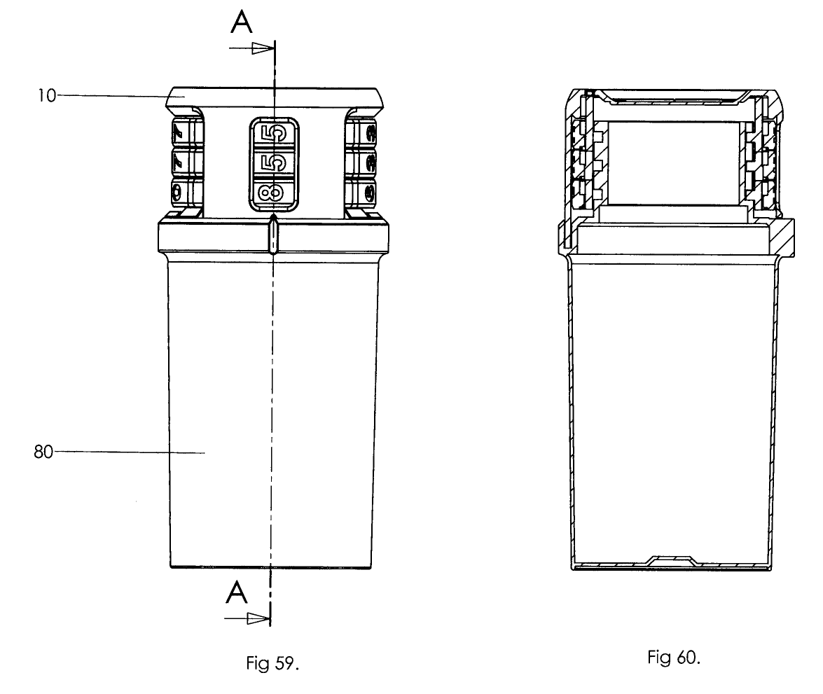

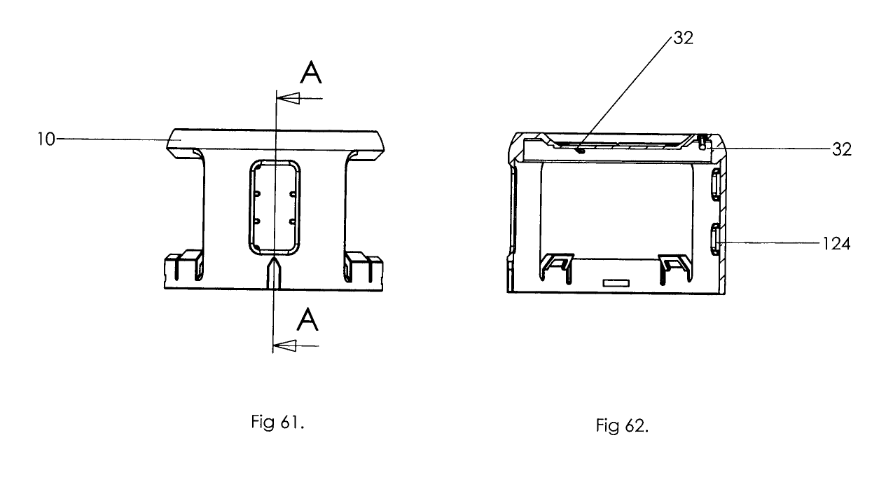

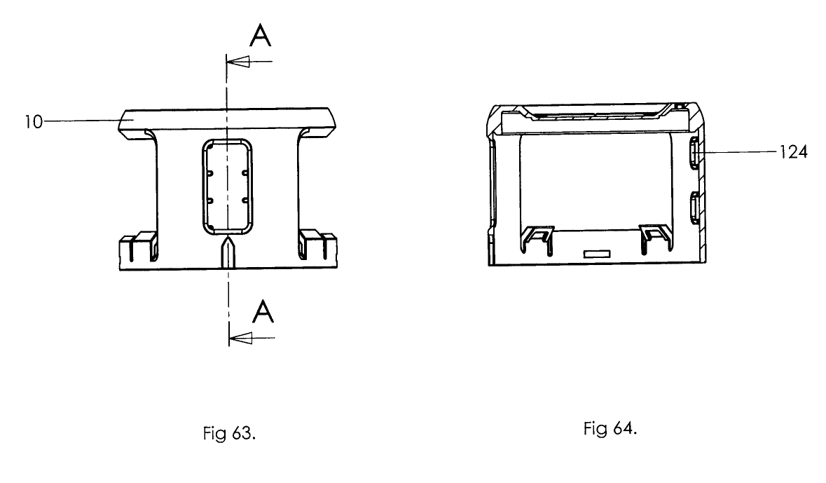

Integrated collapsing part on the inner portion of the housing: FIG. 55-64 show views of another embodiment of the invention that has collapsing part or boss integrated into the inner surface of the housing 10. In the previously discussed versions, there is a separate piece or a collapsing washer has collapsing parts or boss pieces that allows the washer to move vertically or to allow the indicia and tumbler key rings to mover to a second or set position (after the user has set the desired combination and snapped the locking sub-assembly together). In FIG. 55-64, the collapsing, deforming or breaking pieces or parts are integrated into the inner surface of the housing and the washer itself can be eliminated.

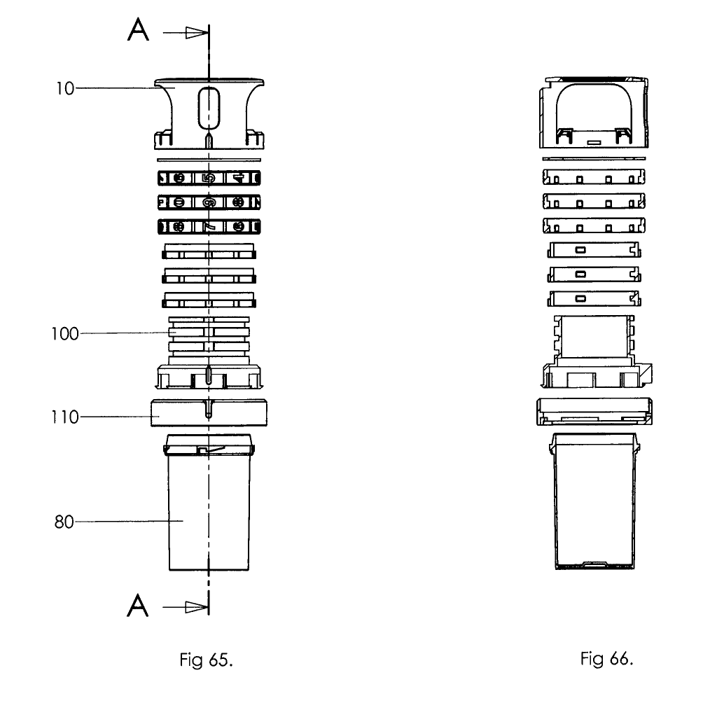

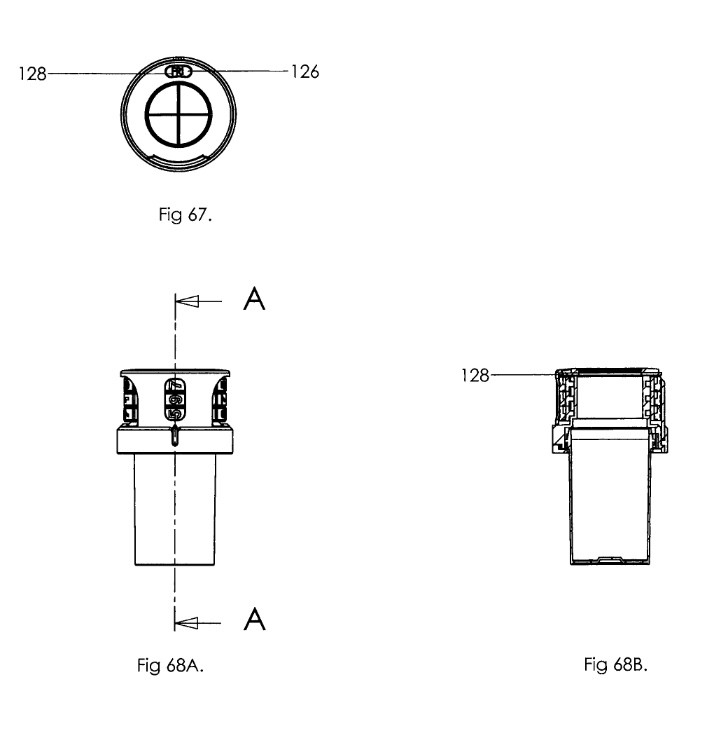

FIG. 65-68 are views of another embodiment that have the day counter indicia on the collapsible washer. The collapsible washer has indicia on the top surface, which can be seen through a window, opening or port on the top surface of the housing.

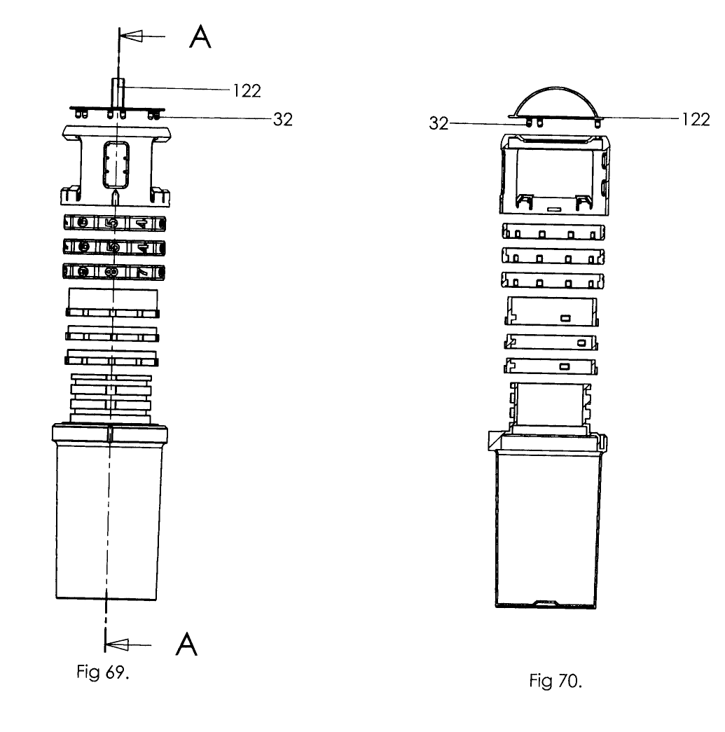

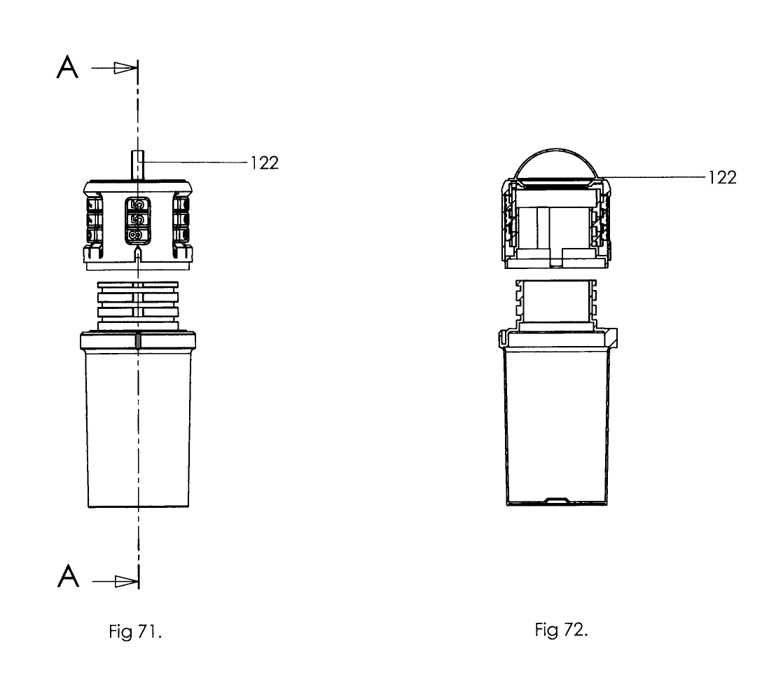

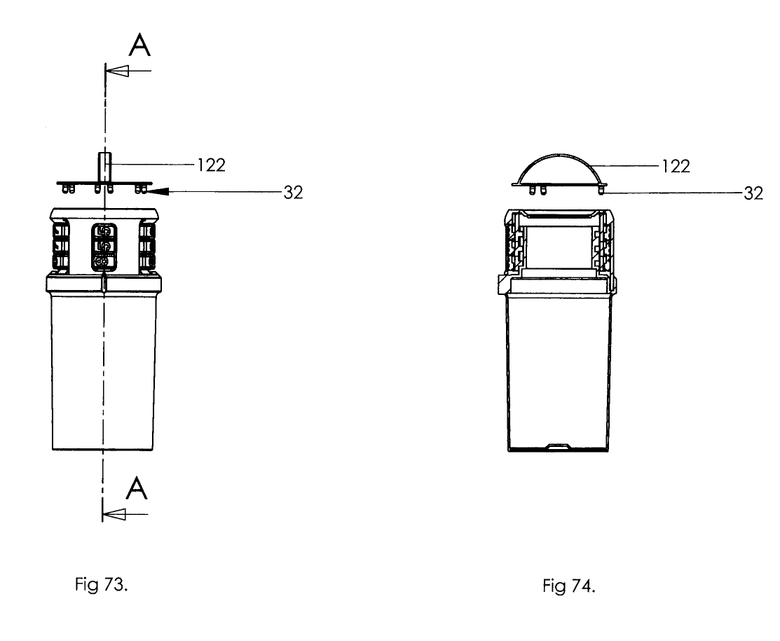

FIG. 69-74 are views of another embodiment with the spacers on a removable tab 122. Instead of breakable portions, the removable tabs has boss parts that provide resistance to allow the indicia and tumbler key rings to mover to a second or set position (after the user has set the desired combination and pushed the locking sub-assembly together). Once the lock has been set, the plug can be removed.

An apparatus for locking a container comprising: a locking assembly comprises: a housing, a collapsing or deforming portion in the housing, at least one indicia ring, at least one tumbler key, a setting plug and a first bracket, the locking assembly engages a second bracket, which sandwiches an opening on the container, whereby after the at least one indicia ring engages the at least one tumbler key at a specific locking combination; the locking assembly is snapped together to break the collapsing portion in the housing to allow the permanent engagement of the specific locking combination of the at least one indicia ring and the at least one tumbler ring to the first bracket; the setting plug is removed; and the locking assembly is permanently engaged to the second bracket so that the container can only be opened with the specific locking combination of the locking assembly. The housing can have a channeled relief surface; at least one display window for viewing the at least one indicia ring; at least one retaining clip on a lower portion of the housing; said at least one retaining clip applies an upward force to help align the at least one indicia ring and at least one tumbler key; at least one detent structure on an inner surface of the housing; the collapsing portion can be on a separate washer, which lies within the housing; the at least one indicia ring has a first side and a second side; the first side has at least one detent receiver space and at least one indicia marking; the second side of the indicia ring has at least one inner engagement boss; the at least one tumbler key has at least one outer engagement portion and at least one vertical channel and at least one horizontal channel; the at least one tumbler key has at least one inner engagement boss on an inner surface of the at least one tumbler key.

An apparatus for locking a container comprising: a locking assembly comprises: a housing, a collapsing portion in the housing, at least one indicia ring, at least one tumbler key, a setting plug and a first bracket, the first bracket is part of the container, whereby after the at least one indicia ring engages the at least one tumbler key at a specific locking combination; the locking assembly is snapped together to deform, stretch or break the collapsing portion in the housing to allow the permanent engagement of the specific locking combination of the at least one indicia ring and the at least one tumbler ring to the first bracket; the setting plug is removed; and the locking assembly is permanently engaged to the first bracket so that the container can only be opened with the specific locking combination of the locking assembly; the housing has a channeled relief surface; at least one display window for viewing the at least one indicia ring; at least one retaining clip on a lower portion of the housing; said at least one retaining clip applies an upward force to help align the at least one indicia ring and at least one tumbler key; and at least one detent structure on an inner surface of the housing.

An apparatus for locking a container comprising: a locking assembly comprises: a housing, a washer, which has a first washer surface with indicia and second washer surface with at least one collapsible portion, at least one indicia ring, at least one tumbler key, a setting plug and a first bracket, the first bracket is part of the container, whereby after the at least one indicia ring engages the at least one tumbler key at a specific locking combination; the locking assembly is snapped together to deform, stretch or break the collapsible portions of the washer to allow the permanent engagement of the specific locking combination of the at least one indicia ring and the at least one tumbler ring to the first bracket; the setting plug is removed; and the locking assembly is permanently engaged to the first bracket so that the container can only be opened with the specific locking combination of the locking assembly.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention. Any heading or section titles are for simple organization for the reader and are not intended to be limiting as to claim scope, construction or interpretation.

1. An apparatus for locking a container comprising:
a locking assembly comprises:
a housing,
a collapsing portion in the housing,
at least one indicia ring,
at least one tumbler key,
a setting plug and
a first bracket,
the locking assembly engages a second bracket, which sandwiches an opening on the container,
whereby after the at least one indicia ring engages the at least one tumbler key at a specific locking combination; the locking assembly is snapped together to break the collapsing portion in the housing to allow the permanent engagement of the specific locking combination of the at least one indicia ring and the at least one tumbler ring to the first bracket; the setting plug is removed; and the locking assembly is permanently engaged to the second bracket so that the container can only be opened with the specific locking combination of the locking assembly.

2. The apparatus for locking a container of claim 1, wherein the housing has a channeled relief surface.

3. The apparatus for locking a container of claim 1, wherein the housing has at least one display window for viewing the at least one indicia ring.

4. The apparatus for locking a container of claim 1, wherein the housing has at least one retaining clip on a lower portion of the housing; said at least one retaining clip applies an upward force to help align the at least one indicia ring and at least one tumbler key.

5. The apparatus for locking a container of claim 1, wherein the collapsing portion is on a separate washer, which lies within the housing.

6. The apparatus for locking a container of claim 1, wherein the housing has at least one detent structure on an inner surface of the housing.

7. The apparatus for locking a container of claim 1, wherein the at least one indicia ring has a first side and a second side; the first side has at least one detent receiver space and at least one indicia marking; the second side of the indicia ring has at least one inner engagement boss.

8. The apparatus for locking a container of claim 1, wherein the at least one tumbler key has at least one outer engagement portion and at least one vertical channel and at least one horizontal channel; the at least one tumbler key has at least one inner engagement boss on an inner surface of the at least one tumbler key.

9. An apparatus for locking a container comprising:
a locking assembly comprises:
a housing,
a collapsing portion in the housing,
at least one indicia ring,
at least one tumbler key,
a setting plug and
a first bracket,
the first bracket is part of the container,
whereby after the at least one indicia ring engages the at least one tumbler key at a specific locking combination; the locking assembly is snapped together to break the collapsing portion in the housing to allow the permanent engagement of the specific locking combination of the at least one indicia ring and the at least one tumbler ring to the first bracket; the setting plug is removed; and the locking assembly is permanently engaged to the first bracket so that the container can only be opened with the specific locking combination of the locking assembly.

10. The apparatus for locking a container of claim 9, wherein the housing has a channeled relief surface.

11. The apparatus for locking a container of claim 9, wherein the housing has at least one display window for viewing the at least one indicia ring.

12. The apparatus for locking a container of claim 9, wherein the housing has at least one retaining clip on a lower portion of the housing; said at least one retaining clip applies an upward force to help align the at least one indicia ring and at least one tumbler key.

13. The apparatus for locking a container of claim 9, wherein the collapsing portion is on a separate washer, which lies within the housing.

14. The apparatus for locking a container of claim 9, wherein the housing has at least one detent structure on an inner surface of the housing.

15. The apparatus for locking a container of claim 9, wherein the at least one indicia ring has a first side and a second side; the first side has at least one detent receiver space and at least one indicia marking; the second side of the indicia ring has at least one inner engagement boss.

16. The apparatus for locking a container of claim 9, wherein the at least one tumbler key has at least one outer engagement portion and at least one vertical channel and at least one horizontal channel; the at least one tumbler key has at least one inner engagement boss on an inner surface of the at least one tumbler key.

17. An apparatus for locking a container comprising:
a locking assembly comprises:
a housing,
a washer, which has a first washer surface with indicia and second washer surface with at least one collapsible portion,
at least one indicia ring,
at least one tumbler key,
a setting plug and
a first bracket,
the first bracket is part of the container,
whereby after the at least one indicia ring engages the at least one tumbler key at a specific locking combination; the locking assembly is snapped together to break the collapsible portions of the washer to allow the permanent engagement of the specific locking combination of the at least one indicia ring and the at least one tumbler ring to the first bracket; the setting plug is removed; and the locking assembly is permanently engaged to the first bracket so that the container can only be opened with the specific locking combination of the locking assembly.

18. The apparatus for locking a container of claim 17, wherein the housing has at least one display window for viewing the at least one indicia ring.

19. The apparatus for locking a container of claim 17, wherein the housing has at least one retaining clip on a lower portion of the housing; said at least one retaining clip applies an upward force to help align the at least one indicia ring and at least one tumbler key.
